(19) United States
(12) Patent Application Publication
(10) Pub. No.: US 2026/0237722 A1
(43) Pub. Date: Aug. 13, 2026

(54) SECONDARY BATTERY MANUFACTURING APPARATUS

(71) Applicant: SK On Co., Ltd., Seoul (KR)

(72) Inventors: Jae Sung BAE, Daejeon (KR); Seung Hyeon CHEON, Daejeon (KR)

(21) Appl. No.: 19/537,499

(22) Filed: Feb. 12, 2026

(30) Foreign Application Priority Data
Feb. 12, 2025 (KR) 10-2025-0017734

(51) Int. Cl. H01M 10/052; H01M 10/04; H01M 10/0566; H01M 50/553

(52) U.S. Cl. CPC H01M 10/052; H01M 10/0404; H01M 10/0566; H01M 50/553

(57) ABSTRACT

A secondary battery manufacturing apparatus is disclosed. The secondary battery manufacturing apparatus includes a temporary pin provided at an electrolyte injection port of an in-process secondary battery so as to be attached thereto and detached therefrom, a vacuum hopper including an internal chamber configured to isolate the electrolyte injection port from the outdoor environment, the vacuum hopper being selectively coupled to the electrolyte injection port, and a pin insert and removal unit disposed in the vacuum hopper, the pin insert and removal unit being configured to insert the temporary pin into the electrolyte injection port and to separate the inserted temporary pin from the electrolyte injection port.

### CROSS-REFERENCE TO RELATED APPLICATION

This application claims the benefit of priority to Korean Patent Application No. 10-2025-0017734 filed on February 12, 2025, the disclosure of which is incorporated herein by reference in its entirety.

### TECHNICAL FIELD

Embodiments of the present disclosure relate to a secondary battery manufacturing apparatus.

### BACKGROUND

A secondary battery is an energy storage means capable of being charged and discharged through electrochemical reaction. Secondary batteries are used in various fields using electrical energy. For example, secondary batteries are widely used in mobile devices such as mobile phones, laptop computers, and tablet computers, and broader utilization thereof is being pursued in transportation equipment such as vehicles, aircraft, and ships. In addition, demand for secondary batteries is increasing in the energy storage system (ESS) field for utilizing surplus power.

Some secondary batteries may use an electrolyte as a medium for ion movement, and the electrolyte may be injected into a case in which an electrode assembly is disposed during a secondary battery manufacturing process. In some embodiments, an in-process secondary battery may be repeatedly transported between indoor and outdoor environments after electrolyte injection. For example, the in-process secondary battery may be transferred to the outdoor environment for aging after electrolyte injection, and then transferred back to the indoor environment, such as a dry room, for activation. As a result, securing a substantial workspace in the dry room is required, and movement of the secondary battery between the outdoor and indoor environments may be repeated before and after each process.

### SUMMARY

Some embodiments of the present disclosure may provide a secondary battery manufacturing apparatus.

In addition, some embodiments of the present disclosure may provide a secondary battery manufacturing apparatus capable of performing processes in an outdoor environment.

In addition, some embodiments of the present disclosure may provide a secondary battery manufacturing apparatus capable of improving the spatial utilization efficiency of a manufacturing environment.

In addition, some embodiments of the present disclosure may provide a secondary battery manufacturing apparatus capable of reducing manufacturing costs.

Some embodiments of the present disclosure may be widely adopted in green technology fields such as electric vehicles, battery charging stations, and other battery-utilizing applications like solar power generation and wind power generation. In addition, some embodiments of the present disclosure may be used in eco-friendly electric vehicles (EVs) and hybrid vehicles (HVs) to prevent climate change by suppressing air pollution and greenhouse gas emissions.

According to an aspect of the present disclosure, a secondary battery manufacturing apparatus includes a temporary pin provided at an electrolyte injection port of an in-process secondary battery so as to be attached thereto and detached therefrom, a vacuum hopper including an internal chamber configured to isolate the electrolyte injection port from an outdoor environment, the vacuum hopper being selectively coupled to the electrolyte injection port, and a pin insert and removal unit disposed in the vacuum hopper, the pin insert and removal unit being configured to insert the temporary pin into the electrolyte injection port and to separate the inserted temporary pin from the electrolyte injection port.

In some embodiments, the temporary pin may include a first coupling region inserted into and fastened to the electrolyte injection port to close the electrolyte injection port and a second coupling region disposed outside the electrolyte injection port, the second coupling region being configured to allow the pin insert and removal unit to be provided thereat so as to be attached thereto and detached therefrom.

In some embodiments, the second coupling region may be made at least partially of an elastic material for attachment and detachment of the pin insert and removal unit.

In some embodiments, the temporary pin may include a pressure application surface configured to allow a pressing force of the pin insert and removal unit to be applied thereto for insertion into the electrolyte injection port and a unit coupling surface configured to allow an operating force of the pin insert and removal unit to be applied thereto for separation from the electrolyte injection port.

In some embodiments, the temporary pin may include an insertion guide surface formed so as to extend obliquely along an outer circumference of the pressure application surface, the insertion guide surface being configured to guide coupling of the pin insert and removal unit.

In some embodiments, the temporary pin may include an elastic edge formed so as to extend outward from the outer circumference of the pressure application surface by a predetermined length in a radial direction, the elastic edge being elastically deformed according to attachment and detachment of the pin insert and removal unit.

In some embodiments, the vacuum hopper may be provided at one end thereof with a contact end configured to be in contact with an outer surface of the in-process secondary battery, and the contact end may be provided with a sealing means configured to isolate the internal chamber from the outdoor environment.

In some embodiments, the pin insert and removal unit may be configured to insert or separate the temporary pin in the state in which the vacuum hopper is coupled to the electrolyte injection port and the internal chamber is isolated from the outdoor environment.

In some embodiments, the pin insert and removal unit may be configured to insert or separate the temporary pin in the state in which the secondary battery manufacturing apparatus is disposed in the outdoor environment.

In some embodiments, the pin insert and removal unit may include a pin removal unit provided to be couplable to the temporary pin, the pin removal unit being configured to separate the temporary pin from the electrolyte injection port, and a pin insertion unit disposed in the pin removal unit, the pin insertion unit being configured to press the temporary pin toward the electrolyte injection port.

In some embodiments, the pin removal unit may be provided with a pin coupling recess coupled to the temporary pin through elastic deformation of the temporary pin.

In some embodiments, the pin removal unit may have an access hole formed at one end thereof disposed toward the temporary pin, and at least a part of the temporary pin may be inserted into the access hole according to movement of the pin removal unit such that the temporary pin is coupled to the pin removal unit.

In some embodiments, the pin insertion unit may be independently movable toward the temporary pin in the pin removal unit.

In some embodiments, the pin insertion unit may move backward in the pin removal unit in a direction opposite a direction in which the temporary pin is disposed for coupling between the pin removal unit and the temporary pin.

In some embodiments, the pin insertion unit may move forward toward the temporary pin in the pin removal unit for separation between the pin removal unit and the temporary pin.

### BRIEF DESCRIPTION OF THE DRAWINGS

FIG. 1 is a view showing a secondary battery manufacturing apparatus according to an embodiment of the present disclosure;

FIG. 2 is a partial enlarged view showing a part of the manufacturing apparatus shown in FIG. 1;

FIG. 3 is a view showing a modified example of a temporary pin shown in FIG. 1;

FIG. 4 is a first operating state view showing the operation of the manufacturing apparatus shown in FIG. 1;

FIG. 5 is a second operating state view showing the operation of the manufacturing apparatus shown in FIG. 1;

FIG. 6 is a third operating state view showing the operation of the manufacturing apparatus shown in FIG. 1;

FIG. 7 is a fourth operating state view showing the operation of the manufacturing apparatus shown in FIG. 1;

FIG. 8 is a fifth operating state view showing the operation of the manufacturing apparatus shown in FIG. 1; and

FIG. 9 is a sixth operating state view showing the operation of the manufacturing apparatus shown in FIG. 1.

### DETAILED DESCRIPTION

Hereinafter, the present disclosure will be described in detail with reference to the accompanying drawings. However, this is merely illustrative, and the present disclosure is not limited to specific embodiments described by way of example.

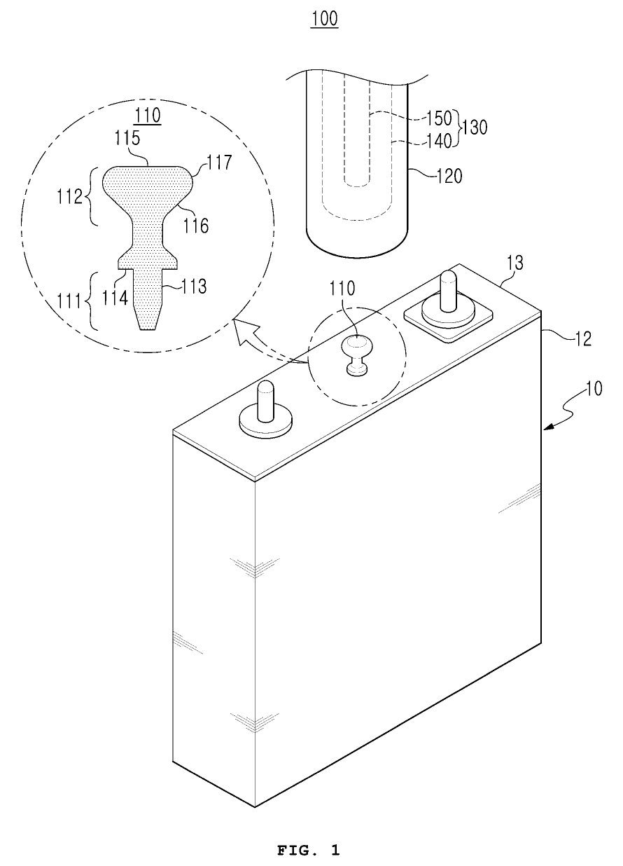

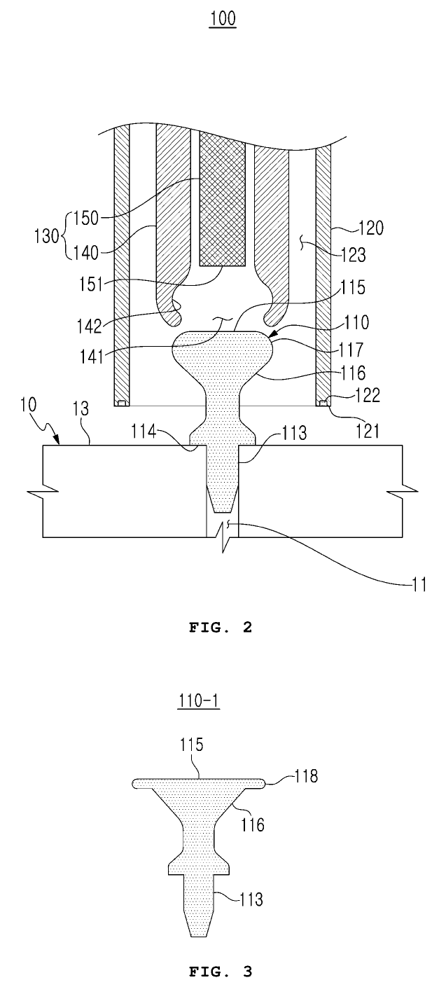

FIG. 1 is a view showing a secondary battery manufacturing apparatus according to an embodiment of the present disclosure. FIG. 2 is a partial enlarged view showing a part of the manufacturing apparatus shown in FIG. 1.

Referring to FIGS. 1 and 2, in some embodiments, a secondary battery manufacturing apparatus (hereinafter referred to as a “manufacturing apparatus 100”) may be provided. In some embodiments, the manufacturing apparatus 100 may be used for an activation process of an in-process secondary battery 10. Specifically, an electrolyte may be injected into the in-process secondary battery 10 and the in-process secondary battery 10 may then undergo an aging process under predetermined conditions such as temperature and humidity. In addition, the secondary battery 10 that has undergone the aging process may undergo processes such as high voltage pre-charge (HVPC) and degassing in the manufacturing apparatus 100.

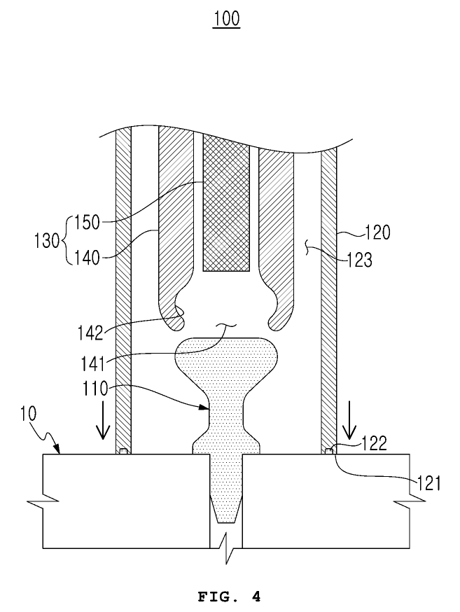

In some embodiments, the manufacturing apparatus 100 may be configured to attach and detach a temporary pin 110 to and from the in-process secondary battery 10 during the activation process described above. That is, the manufacturing apparatus 100 may be configured to close an electrolyte injection port 11 of the in-process secondary battery 10 by coupling the temporary pin 110 to the electrolyte injection port 11 or to open the electrolyte injection port 11 by separating the coupled temporary pin 110 from the electrolyte injection port 11. For example, the manufacturing apparatus 100 may be configured to separate the temporary pin 110 from the electrolyte injection port 11 for processes such as high voltage pre-charge and degassing and to re-couple the temporary pin 110 to the secondary battery 10 after completion of the high voltage pre-charge and degassing processes to close the electrolyte injection port 11. The operation of the manufacturing apparatus 100 will be described in more detail with reference to FIGS. 4 to 9.

However, in the embodiment of the present disclosure, the purposes and functions of the manufacturing apparatus 100 are not necessarily limited to those illustrated above. The manufacturing apparatus 100 may be utilized for various purposes and functions beyond those illustrated above, provided the manufacturing apparatus appropriately incorporates the technical concepts described below. For example, the manufacturing apparatus 100 may be appropriately employed in various process steps in which the electrolyte injection port 11 of the secondary battery 10 needs to be opened or closed in an environment isolated from an outdoor environment.

In addition, the in-process secondary battery 10 may be any type of secondary battery 10 requiring electrolyte injection during the process step. For example, the in-process secondary battery 10 may be a prismatic battery, a cylindrical battery, a pouch-shaped battery, a coin battery, or a battery of other non-generic shapes. In the shown embodiment, the in-process secondary battery 10 is illustrated as a prismatic battery.

In some embodiments, the in-process secondary battery 10 may include an electrolyte injection port 11. For example, the in-process secondary battery 10 may include a case 12 having an electrode assembly received therein and a cap plate 13 configured to close an opening formed in an upper end of the case 12, wherein the cap plate 13 may be provided with an electrolyte injection port 11 configured to allow an electrolyte to be injected into the case 12 therethrough.

Meanwhile, in some embodiments, the manufacturing apparatus 100 may include a temporary pin 110 provided at the electrolyte injection port 11 of the in-process secondary battery 10 so as to be attached thereto and detached therefrom, a vacuum hopper 120 including an internal chamber 123 configured to isolate the electrolyte injection port 11 from the outdoor environment, the vacuum hopper 120 being selectively coupled to the electrolyte injection port 11, and a pin insert and removal unit 130 disposed in the vacuum hopper 120, the pin insert and removal unit 130 being configured to insert the temporary pin 110 into the electrolyte injection port 11 and to separate the inserted temporary pin 110 from the electrolyte injection port 11.

Specifically, in some embodiments, the manufacturing apparatus 100 may include a temporary pin 110. The temporary pin 110 may be coupled to the electrolyte injection port 11 to close the electrolyte injection port 11, or may be separated from the electrolyte injection port 11 to open the electrolyte injection port 11. That is, the in-process secondary battery 10 may be configured such that the electrolyte injection port 11 is opened and closed by the temporary pin 110.

Referring to the enlarged view of FIG. 2, in some embodiments, the temporary pin 110 may include a first coupling region 111. The first coupling region 111 may be provided in a lower region of the temporary pin 110. The first coupling region 111 may be configured to close the electrolyte injection port 11. For example, the first coupling region 111 may include a sealing surface 113 formed on an outer circumferential surface thereof, wherein the sealing surface 113 may be in tight contact with an inner circumferential surface of the electrolyte injection port 11 to close the electrolyte injection port 11.

In some embodiments, the temporary pin 110 may include a second coupling region 112. The second coupling region 112 may be provided in an upper region of the temporary pin 110. In addition, the second coupling region 112 may be disposed outside the electrolyte injection port 11. That is, the temporary pin 110 may be configured such that the lower first coupling region 111 is coupled to the electrolyte injection port 11 to close the electrolyte injection port 11 and the upper second coupling region 112 is exposed outside the electrolyte injection port 11. Accordingly, the pin insert and removal unit 130, described below, may be attached to and detached from the temporary pin 110 via the second coupling region 112. In some embodiments, a stopper 114 may be provided between the first and second coupling regions 111 and 112. The stopper 114 may be supported on an upper surface of the cap plate 13 to regulate an insertion range of the temporary pin 110.

In some embodiments, the second coupling region 112 may be provided at the pin insert and removal unit 130 so as to be attached thereto and detached therefrom. That is, the second coupling region 112 may be provided at the pin insert and removal unit 130 so as to be coupled thereto and separated therefrom. Accordingly, the pin insert and removal unit 130 may be appropriately separated from the temporary pin 110 after coupling the temporary pin 110 to the electrolyte injection port 11 or may be re-coupled to the temporary pin 110 in order to remove the temporary pin 110 coupled to the electrolyte injection port 11.

In some embodiments, the temporary pin 110 may be made partially or entirely of an elastic material. Specifically, the first coupling region 111 may be made partially or entirely of an elastic material to enable attachment and detachment to and from the electrolyte injection port 11 and appropriate closing of the electrolyte injection port 11. In addition, the second coupling region 112 may be made partially or entirely of an elastic material to enable appropriate attachment and detachment of the pin insert and removal unit 130. In some embodiments, the entirety of the temporary pin 110, including the first and second coupling regions 111 and 112, may be made of a single elastic material.

In some embodiments, the temporary pin 110 may include a pressure application surface 115. A pressing force from the pin insert and removal unit 130 may be applied to the pressure application surface 115. That is, a predetermined pressing force may be applied to the pressure application surface 115 via the pin insert and removal unit 130, thereby enabling the temporary pin 110 to be appropriately inserted into and fastened to the electrolyte injection port 11. In some embodiments, the pressure application surface 115 may be provided as a predetermined plane extending from an upper end of the second coupling region 112 in a transverse direction. As a result, the pressing force from the pin insert and removal unit 130 may be appropriately applied to the pressure application surface 115.

In some embodiments, the temporary pin 110 may include a unit coupling surface 116. The unit coupling surface 116 may be provided on the second coupling region 112 exposed outside the electrolyte injection port 11. An operating force from the pin insert and removal unit 130 for separating the temporary pin 110 may be applied to the unit coupling surface 116. That is, the pin insert and removal unit 130 may be coupled to the unit coupling surface 116 to separate the temporary pin 110, and may apply an operating force to the temporary pin 110 via the unit coupling surface 116 to separate the temporary pin 110 from the electrolyte injection port 11.

The unit coupling surface 116 may be configured as described above to allow the pin insert and removal unit 130 to be appropriately coupled thereto and to apply an operating force to the temporary pin 110. In addition, the unit coupling surface 116 may be configured to be appropriately separated from the pin insert and removal unit 130. In some embodiments, the unit coupling surface 116 may be provided as an inclined surface extending downward toward the center of the temporary pin 110 at a predetermined angle. For example, the unit coupling surface 116 may be provided as an inclined surface extending downward toward the center of the temporary pin 110 at an inclination angle of 30 to 60 degrees relative to a central axis of the temporary pin 110. The unit coupling surface 116 may function, together with the elastic material of the temporary pin 110, to induce appropriate coupling and separation of the pin insert and removal unit 130.

In some embodiments, the temporary pin 110 may include an insertion guide surface 117. The insertion guide surface 117 may be provided along an outer circumference of the pressure application surface 115. In addition, the insertion guide surface 117 may be formed so as to extend downward at a predetermined angle from the pressure application surface 115, which is approximately planar, in a direction outward from the pressure application surface 115. The insertion guide surface 117 may function to guide the coupling of the pin insert and removal unit 130. That is, the pin insert and removal unit 130 may slide along the insertion guide surface 117 in contact therewith, whereby coupling of the pin insert and removal unit 130 to the unit coupling surface 116 may be appropriately guided.

FIG. 3 is a view showing a modified example of the temporary pin shown in FIG. 1.

Referring to FIG. 3, the temporary pin 110-1 may be modified into various forms as long as the temporary pin can be appropriately attached to and detached from the electrolyte injection port 11. FIG. 3 illustrates an example in which an elastic edge 118 is provided along the outer circumference of the pressure application surface 115. Specifically, in some embodiments, the temporary pin 110-1 may include an elastic edge 118, wherein the elastic edge 118 may extend outward from the outer circumference of the pressure application surface 115 by a predetermined length in a radial direction. The elastic edge 118 may replace the insertion guide surface 117 or may be added to the insertion guide surface 117. The elastic edge 118 may generally perform a function similar to that of the insertion guide surface 117. That is, the elastic edge 118 may function to guide attachment and detachment of the pin insert and removal unit 130 while being elastically deformed according to attachment and detachment of the pin insert and removal unit 130.

Referring back to FIGS. 1 and 2, in some embodiments, the manufacturing apparatus 100 may include a vacuum hopper 120. The vacuum hopper 120 may include an internal chamber 123 configured to isolate the electrolyte injection port 11 from the outdoor environment. That is, the vacuum hopper 120 may be fastened to a part of the upper surface of the cap plate 13 such that the electrolyte injection port 11 is included therein, whereby the electrolyte injection port 11 is disposed in the vacuum hopper 120 so as to be isolated from the outdoor environment. The vacuum hopper 120 may prevent moisture, foreign matter, etc., in the outside air from entering the in-process secondary battery 10 during opening and closing of the electrolyte injection port 11.

In some embodiments, the vacuum hopper 120 may be selectively coupled to the electrolyte injection port 11. That is, the vacuum hopper 120 may be coupled to the electrolyte injection port 11 in order to isolate the electrolyte injection port 11 from the outdoor environment, or may be appropriately separated from the electrolyte injection port 11 in order to transfer the in-process secondary battery 10 to the next process. In the latter case, the electrolyte injection port 11 may be separated from the vacuum hopper 120 in a state of being appropriately closed by the temporary pin 110 or the like.

In some embodiments, a contact end 121 may be provided at one end of the vacuum hopper 120. In the shown embodiment, the contact end 121 may be provided at a lower end of the vacuum hopper 120. The contact end 121 may be brought into tight contact with an outer surface of the secondary battery 10 upon coupling of the vacuum hopper 120. That is, in the shown embodiment, the contact end 121 may be in tight contact with the upper surface of the cap plate 13 surrounding the electrolyte injection port 11. As a result, the internal chamber 123 may be appropriately isolated from the outdoor environment. In some embodiments, the contact end 121 may be provided with a sealing means 122. For example, the sealing means 122 may include an O-ring extending along the contact end 121. The sealing means 122 enables the internal chamber 123 to be more completely isolated from the outdoor environment.

Meanwhile, in some embodiments, the manufacturing apparatus 100 may include a pin insert and removal unit 130. The pin insert and removal unit 130 may be configured to attach and detach the temporary pin 110 to and from the electrolyte injection port 11. That is, the pin insert and removal unit 130 may insert the temporary pin 110 into the electrolyte injection port 11 to close the electrolyte injection port 11, or may separate the temporary pin 110 from the electrolyte injection port 11 to open the electrolyte injection port 11.

In some embodiments, the pin insert and removal unit 130 may be disposed in the vacuum hopper 120. That is, the pin insert and removal unit 130 may be disposed in the internal chamber 123. In some embodiments, the pin insert and removal unit 130 may be configured to attach and detach the temporary pin 110 to and from the electrolyte injection port 11 in the state in which the internal chamber 123 is isolated from the outdoor environment. That is, the pin insert and removal unit 130 may be configured to attach and detach the temporary pin 110 to and from the electrolyte injection port 11 in the state in which the vacuum hopper 120 is coupled to the electrolyte injection port 11. The pin insert and removal unit 130 may function to reduce exposure of the electrolyte injection port 11 to the outdoor environment and prevent moisture, foreign matter, etc., in the outside air from entering through the open electrolyte injection port 11.

In some embodiments, the pin insert and removal unit 130 may be configured to attach and detach the temporary pin 110 in an outdoor environment. That is, the pin insert and removal unit 130 may be configured to insert or remove the temporary pin 110 in the state in which the manufacturing apparatus 100 or the in-process secondary battery is disposed in the outdoor environment. For example, a secondary battery 10 that has undergone an aging process may have the temporary pin 110 removed through the pin insert and removal unit 130 in a state of being disposed in the outdoor environment. In addition, the secondary battery 10 with the temporary pin 110 removed in this manner may undergo processes such as high voltage pre-charge and degassing while placed in the outdoor environment. Here, the vacuum hopper 120 may remain coupled to the electrolyte injection port 11, thereby appropriately limiting the exposure of the electrolyte injection port 11 to the outdoor environment. This will be elaborated upon in relation to the operation of the present disclosure.

Meanwhile, in some embodiments, the pin insert and removal unit 130 may include a pin removal unit 140 and a pin insertion unit 150. The pin removal unit 140 may be configured to separate the temporary pin 110 from the electrolyte injection port 11. In addition, the pin insertion unit 150 may be configured to insert and couple the temporary pin 110 into and to the electrolyte injection port 11. In some embodiments, both the pin removal unit 140 and the pin insertion unit 150 may be disposed in the vacuum hopper 120. In addition, the pin insertion unit 150 may be disposed in the pin removal unit 140.

Specifically, in some embodiments, the pin removal unit 140 may extend vertically by a predetermined length in the vacuum hopper 120. In addition, a placement space in which the pin insertion unit 150, described below, is disposed may be provided in the pin removal unit 140. The placement space may extend to a predetermined extent in a longitudinal direction of the pin removal unit 140. In addition, an access hole 141 may be provided in a lower end of the pin removal unit 140. The access hole 141 may be connected to the interior of the pin removal unit 140 to provide an operating passage through which the pin insertion unit 150 can be exposed toward the temporary pin 110. In addition, the access hole 141 may provide an insertion passage through which the pin insertion unit 150 can be inserted into a pin coupling recess 142, described below.

In some embodiments, the pin removal unit 140 may include a pin coupling recess 142. The pin coupling recess 142 may be provided at an inner lower end of the pin removal unit 140 so as to be adjacent to the access hole 141. The pin coupling recess 142 may be provided at the temporary pin 110 so as to be attached thereto and detached therefrom. For example, the pin coupling recess 142 may have a shape corresponding to the unit coupling surface 116 and may be fitted to the temporary pin 110. As described above, the temporary pin 110 may be made at least partially of an elastic material, and the temporary pin 110 may be fitted into the pin coupling recess 142 through elastic deformation. The temporary pin 110 may be inserted into and coupled to the pin coupling recess 142 as the pin removal unit 140 descends, and may be detached and separated from the pin coupling recess 142 as the pin removal unit 140 ascends.

Meanwhile, in some embodiments, the pin insert and removal unit 130 may include a pin insertion unit 150 disposed in the pin removal unit 140. The pin insertion unit 150 may be provided in the pin removal unit 140 so as to be movable forward toward the access hole 141 and backward away from the access hole 141. That is, the pin insertion unit 150 may be moved downward to advance toward the access hole 141 or moved upward to retract from the access hole 141.

In some embodiments, the pin insertion unit 150 may be provided in the form of a rod extending along the interior of the pin removal unit 140. In addition, a pressing end 151 may be provided at a lower end of the pin insertion unit 150. The pressing end 151 may come into contact with the pressure application surface 115 to press the pressure application surface 115 toward the access hole 141 as the pin insertion unit 150 advances toward the temporary pin 110. As a result, the temporary pin 110 coupled to the pin coupling recess 142 may be appropriately separated from the pin removal unit 140. This will be elaborated upon in relation to the operation of this embodiment.

In some embodiments, the pin insertion unit 150 may be independently movable forward and backward in the pin removal unit 140. That is, in the stationary pin removal unit 140, the pin insertion unit 150 may independently advance toward the access hole 141 or independently retract from the access hole 141. Consequently, the pin insertion unit 150 may function to appropriately separate the temporary pin 110 coupled to the pin removal unit 140.

FIGS. 4 to 9 are operating state views showing the operation of the manufacturing apparatus shown in FIG. 1.

Hereinafter, the operation of the manufacturing apparatus 100 will be described by way of example. However, the specific operation and usage methods of the manufacturing apparatus 100 may be appropriately modified as needed and are not necessarily limited to the following operational examples.

FIG. 4 is a first operating state view showing the operation of the manufacturing apparatus shown in FIG. 1.

Referring to FIG. 4, the in-process secondary battery 10 may be provided. In some operational examples, the in-process secondary battery 10 may be provided in the state in which the electrolyte has been injected thereinto. That is, the in-process secondary battery 10 may be provided in the state in which the electrolyte has been injected thereinto in a dry room, etc., and the electrolyte injection port 11 is closed by the temporary pin 110. In some operational examples, the secondary battery 10 with the electrolyte injected in this manner may be transferred to an outdoor environment to undergo an aging process.

Meanwhile, upon completion of aging, the vacuum hopper 120 may be coupled to the in-process secondary battery 10. As in the shown operation example, the vacuum hopper 120 may be operated such that the contact end 121 comes into tight contact with the circumference of the electrolyte injection port 11, thereby appropriately isolating the internal chamber 123 from the outdoor environment. In addition, as the vacuum hopper 120 appropriately seals the internal chamber 123 in this manner, subsequent operational processes, described below, may be performed in an outdoor environment. That is, subsequent operational processes, described below, may be performed for the secondary battery 10, which has undergone aging in the outdoor environment, in the outdoor environment without needing to be transferred back to an indoor environment such as the dry room.

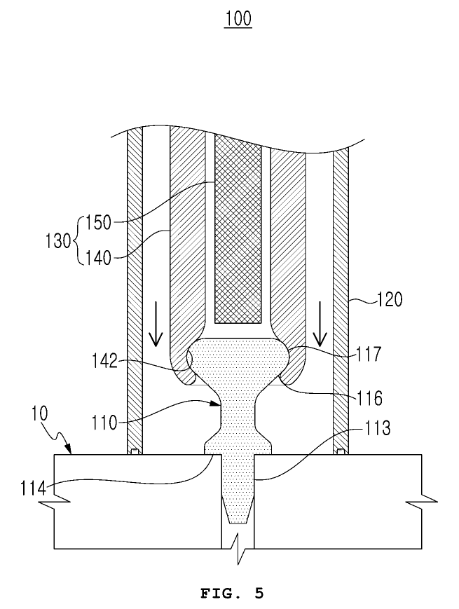

FIG. 5 is a second operating state view showing the operation of the manufacturing apparatus shown in FIG. 1.

Referring to FIG. 5, the pin insert and removal unit 130 may be subsequently coupled to the temporary pin 110 in the vacuum hopper 120. Specifically, the pin insert and removal unit 130 may descend toward the temporary pin 110. Accordingly, the second coupling region 112 may be inserted into the access hole 141, and therefore the temporary pin 110 may be coupled to the pin coupling recess 142. That is, the temporary pin 110 and the pin removal unit 140 may be coupled to each other. Here, the temporary pin 110 may be coupled to the pin coupling recess 142 while a part of the second coupling region 112 is elastically deformed, and the unit coupling surface 116 may be seated in the pin coupling recess 142 such that a predetermined operating force from the pin removal unit 140 is applied to the temporary pin 110.

In the above, the pin insertion unit 150 may retract (ascend) such that the pin coupling recess 142 is appropriately exposed. That is, for coupling between the pin removal unit 140 and the temporary pin 110, the pin insertion unit 150 may retract in a direction (i.e., upward) opposite the direction in which the temporary pin 110 is disposed. As a result, the pin coupling recess 142 may be appropriately exposed at the inner lower end of the pin removal unit 140, and the temporary pin 110 may be coupled to the exposed pin coupling recess 142.

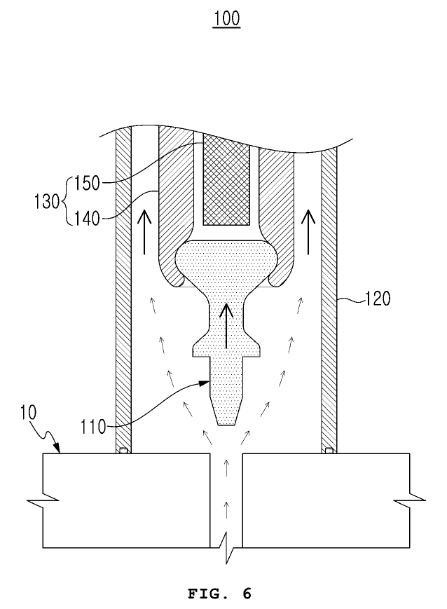

FIG. 6 is a third operating state view showing the operation of the manufacturing apparatus shown in FIG. 1.

Referring to FIG. 6, the pin insert and removal unit 130 may subsequently ascend, whereby the temporary pin 110 may be separated from the electrolyte injection port 11. The temporary pin 110 may be separated from the electrolyte injection port 11 in a state of being coupled to the pin coupling recess 142. In addition, processes such as high voltage pre-charge and degassing may be performed in the state in which the electrolyte injection port 11 is open. Gas generated during the degassing process, etc., may be discharged to the outside through the internal chamber 123. As described above, the internal chamber 123 may remain isolated from the outdoor environment, and therefore the ingress of moisture, foreign matter, etc., in the outside air during the degassing process, etc., may be appropriately restricted.

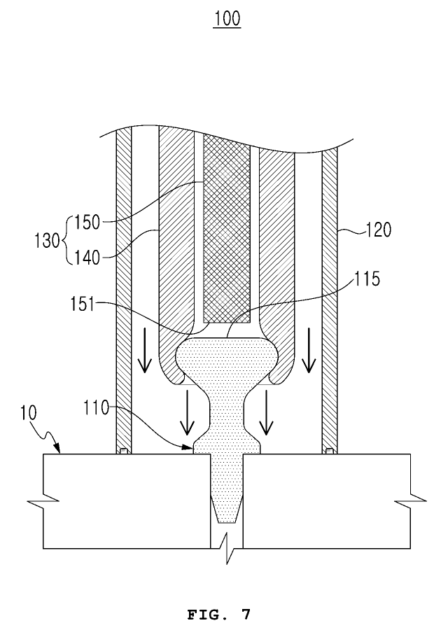

FIG. 7 is a fourth operating state view showing the operation of the manufacturing apparatus shown in FIG. 1.

Referring to FIG. 7, once the high voltage pre-charge and degassing processes are completed, the temporary pin 110 may be re-coupled to the electrolyte injection port 11. Specifically, the pin insert and removal unit 130 may descend again toward the electrolyte injection port 11, and the first coupling region 111 of the temporary pin 110 may be inserted into the electrolyte injection port 11. In some operational examples, this step may be performed such that only a part of the first coupling region 111 is inserted into the electrolyte injection port 11. That is, in this step, the temporary pin 110 may be disposed in the electrolyte injection port 11 in a sort of pre-assembled state. More complete coupling between the temporary pin 110 and the electrolyte injection port 11 may be performed through the pin insertion unit 150, described below.

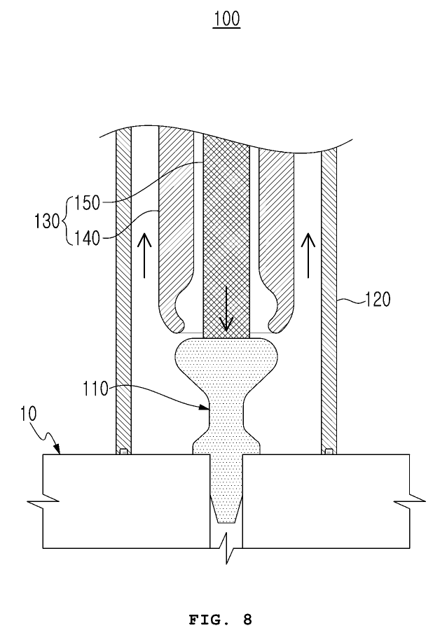

FIG. 8 is a fifth operating state view showing the operation of the manufacturing apparatus shown in FIG. 1.

Referring to FIG. 8, the pin insertion unit 150 may subsequently advance (descend) toward the temporary pin 110. That is, in the pin removal unit 140, the pin insertion unit 150 may descend a predetermined distance toward the temporary pin 110. Accordingly, the pressing end 151 of the pin insertion unit 150 may downwardly push the pressure application surface 115 of the temporary pin 110, whereby the temporary pin 110 may be pressed toward the electrolyte injection port 11. In some operational examples, the temporary pin 110 pre-assembled in the electrolyte injection port 11 may be more completely coupled to the electrolyte injection port 11 by pressing of the pin insertion unit 150.

Meanwhile, in conjunction with the operation of the pin insertion unit 150 described above, the pin removal unit 140 may be separated from the temporary pin 110. Specifically, the pin removal unit 140 may move upward relative to the pin insertion unit 150 in the state in which the pin insertion unit 150 is pressing the temporary pin 110 downward. Accordingly, the temporary pin 110 may be detached from the pin coupling recess 142 and thus separated from the pin removal unit 140. For such appropriate separation of the pin removal unit 140, the pin insertion unit 150 may continue to press the temporary pin 110 at least until the pin removal unit 140 is completely separated.

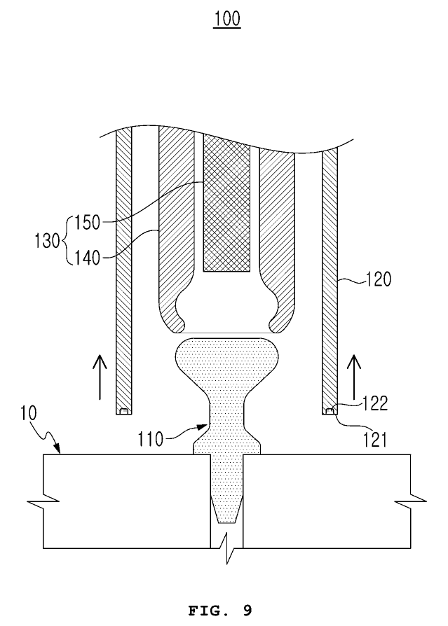

FIG. 9 is a sixth operating state view showing the operation of the manufacturing apparatus shown in FIG. 1.

Referring to FIG. 9, once the temporary pin 110 is re-coupled to the electrolyte injection port 11 as described above, the pin insertion unit 150 may retract (ascend) back to the initial position thereof. In addition, the vacuum hopper 120 may be separated from the in-process secondary battery 10. Since the electrolyte injection port 11 is appropriately closed by the temporary pin 110, the ingress of moisture, foreign matter, etc., in the external atmosphere may be appropriately restricted despite the separation of the vacuum hopper 120. The in-process secondary battery 10 may be transferred to a subsequent process step in the state in which the electrolyte injection port 11 is closed. The subsequent process step may be performed in the indoor environment or the outdoor environment, and is not particularly restricted in this operational example.

As is apparent from the above description, some embodiments of the present disclosure may provide a secondary battery manufacturing apparatus.

In addition, some embodiments of the present disclosure may provide a secondary battery manufacturing apparatus capable of performing processes in an outdoor environment. In some embodiments, a vacuum hopper is configured to appropriately isolate an electrolyte injection port from the outdoor environment, and a pin insert and removal unit is configured to open and close the electrolyte injection port in an internal chamber isolated from the outdoor environment, thereby contributing to process execution in the outdoor environment.

In addition, some embodiments of the present disclosure may provide a secondary battery manufacturing apparatus capable of improving the spatial utilization efficiency of a manufacturing environment. In some embodiments, the manufacturing apparatus is configured to perform opening and closing of the electrolyte injection port in the outdoor environment, allowing subsequent process steps requiring opening and closing of the electrolyte injection port, such as high voltage pre-charge and degassing, to be appropriately performed in the outdoor environment. Appropriate utilization of the outdoor environment may contribute to improving the spatial utilization efficiency of limited manufacturing facilities, such as a dry room.

In addition, some embodiments of the present disclosure may provide a secondary battery manufacturing apparatus capable of reducing manufacturing costs. In some embodiments, utilizing the outdoor environment may increase the operational efficiency of limited manufacturing facilities, such as the dry room, and contribute to reducing the construction costs of manufacturing facilities. In addition, such increases in operational efficiency or reductions in facility costs may contribute to reducing the manufacturing costs of secondary batteries.

The above description is merely an example applying the principles of the present disclosure, and other configurations may be further included without departing from the scope of the present disclosure.

What is claimed is:

1. A secondary battery manufacturing apparatus comprising:
a temporary pin provided at an electrolyte injection port of an in-process secondary battery so as to be attached thereto and detached therefrom;
a vacuum hopper comprising an internal chamber configured to isolate the electrolyte injection port from an outdoor environment, the vacuum hopper being selectively coupled to the electrolyte injection port; and
a pin insert and removal unit disposed in the vacuum hopper, the pin insert and removal unit being configured to insert the temporary pin into the electrolyte injection port and to separate the inserted temporary pin from the electrolyte injection port.

2. The secondary battery manufacturing apparatus according to claim 1, wherein the temporary pin comprises:
a first coupling region inserted into and fastened to the electrolyte injection port to close the electrolyte injection port; and
a second coupling region disposed outside the electrolyte injection port, the second coupling region being configured to allow the pin insert and removal unit to be provided thereat so as to be attached thereto and detached therefrom.

3. The secondary battery manufacturing apparatus according to claim 2, wherein the second coupling region is made at least partially of an elastic material for attachment and detachment of the pin insert and removal unit.

4. The secondary battery manufacturing apparatus according to claim 1, wherein the temporary pin comprises:
a pressure application surface configured to allow a pressing force of the pin insert and removal unit to be applied thereto for insertion into the electrolyte injection port; and
a unit coupling surface configured to allow an operating force of the pin insert and removal unit to be applied thereto for separation from the electrolyte injection port.

5. The secondary battery manufacturing apparatus according to claim 4, wherein the temporary pin comprises an insertion guide surface formed so as to extend obliquely along an outer circumference of the pressure application surface, the insertion guide surface being configured to guide coupling of the pin insert and removal unit.

6. The secondary battery manufacturing apparatus according to claim 4, wherein the temporary pin comprises an elastic edge formed so as to extend outward from an outer circumference of the pressure application surface by a predetermined length in a radial direction, the elastic edge being elastically deformed according to attachment and detachment of the pin insert and removal unit.

7. The secondary battery manufacturing apparatus according to claim 1, wherein
the vacuum hopper is provided at one end thereof with a contact end configured to be in contact with an outer surface of the in-process secondary battery, and
the contact end is provided with a sealing means configured to isolate the internal chamber from the outdoor environment.

8. The secondary battery manufacturing apparatus according to claim 1, wherein the pin insert and removal unit is configured to insert or separate the temporary pin in a state in which the vacuum hopper is coupled to the electrolyte injection port and the internal chamber is isolated from the outdoor environment.

9. The secondary battery manufacturing apparatus according to claim 8, wherein the pin insert and removal unit is configured to insert or separate the temporary pin in a state in which the secondary battery manufacturing apparatus is disposed in the outdoor environment.

10. The secondary battery manufacturing apparatus according to claim 1, wherein the pin insert and removal unit comprises:
a pin removal unit provided to be couplable to the temporary pin, the pin removal unit being configured to separate the temporary pin from the electrolyte injection port; and
a pin insertion unit disposed in the pin removal unit, the pin insertion unit being configured to press the temporary pin toward the electrolyte injection port.

11. The secondary battery manufacturing apparatus according to claim 10, wherein the pin removal unit is provided with a pin coupling recess coupled to the temporary pin through elastic deformation of the temporary pin.

12. The secondary battery manufacturing apparatus according to claim 10, wherein
the pin removal unit has an access hole formed at one end thereof disposed toward the temporary pin, and
at least a part of the temporary pin is inserted into the access hole according to movement of the pin removal unit such that the temporary pin is coupled to the pin removal unit.

13. The secondary battery manufacturing apparatus according to claim 10, wherein the pin insertion unit is independently movable toward the temporary pin in the pin removal unit.

14. The secondary battery manufacturing apparatus according to claim 10, wherein the pin insertion unit moves backward in the pin removal unit in a direction opposite a direction in which the temporary pin is disposed for coupling between the pin removal unit and the temporary pin.

15. The secondary battery manufacturing apparatus according to claim 10, wherein the pin insertion unit moves forward toward the temporary pin in the pin removal unit for separation between the pin removal unit and the temporary pin.
